(19) United States
(12) Patent Application Publication
(10) Pub. No.: US 2026/0211537 A1
(43) Pub. Date: Jul. 23, 2026

(54) Operating System, in Particular for a Self-Propelled Construction Machine

(71) Applicant: Hamm AG, Tirschenreuth (DE)

(72) Inventors: Marco KREGER, Tirschenreuth (DE); Gernot REIF, Erlangen (DE); Michael GMEINER, Tirschenreuth (DE); Rainer KROCKAUER, Plößberg (DE)

(21) Appl. No.: 19/453,224

(22) Filed: Jan. 20, 2026

(30) Foreign Application Priority Data
Jan. 22, 2025 (DE) 10 2025 102 191.0

(51) Int. Cl. G06F 3/0484; E01C 19/26; G06F 3/0482; G06F 3/0488

(52) U.S. Cl. CPC G06F 3/0484; E01C 19/26; G06F 3/0482; G06F 3/0488; E01C 2301/30

(57) ABSTRACT

An operating system, in particular for a self-propelled construction machine, comprises a first operating element (28), wherein the first operating element (28) is to be moved in a first type of movement for selection of a function from a plurality of selectable functions and is to be moved in a second type of movement for confirming the selection of a function from the plurality of selectable functions, wherein a first illumination unit (36) is assigned to the first operating element (28) for illuminating the first operating element (28), as well as a display screen for displaying the functions selectable and/or selected by means of the first operating element (28), wherein at least one, preferably each, function of the plurality of selectable functions is assigned a function color code, and wherein the first illumination unit (36) is configured to illuminate the first operating element (28) in a color corresponding to the function color code of the selected function, after selection and/or confirming the selection of one of the functions by means of the first operating element (28).

The present invention relates to an operating system which can be utilized to operate a self-propelled construction machine, such as a self-propelled ground compactor or the like.

Since self-propelled construction machines feature a plurality of functions that can be optionally activated or deactivated by an operator, or varied in their intensity, for example, it is necessary to provide operating systems by means of which various functions can be selected and activated or deactivated. For example, so-called rotary/push controllers can be utilized, with which, for instance, a selection can be made by rotating, and a confirmation of the selection or an activation or deactivation of the selected function can occur by pushing. Other known operating systems utilize, alternatively or additionally, touchscreens, by means of which functions can be selected or selected functions can be activated and deactivated by touching a touch-sensitive display screen.

The object of the present invention is to provide an operating system, in particular for a self-propelled construction machine, which, while being easy to operate, contributes to avoiding the occurrence of operating errors.

According to the invention, this object is solved by an operating system, in particular for a self-propelled construction machine, comprising:
a first operating element, wherein the first operating element is to be moved in a first type of movement for selection of a function from a plurality of selectable functions and is to be moved in a second type of movement for confirming the selection of a function from the plurality of selectable functions, wherein a first illumination unit is assigned to the first operating element for illuminating the first operating element,
a display screen for displaying the functions selectable and/or selected by means of the first operating element,
wherein at least one, preferably each, function of the plurality of selectable functions is assigned a function color code, and wherein the first illumination unit is configured to illuminate the first operating element in a color corresponding to the function color code of the selected function, after selection and/or confirming the selection of one of the functions by means of the first operating element.

In the operating system according to the invention, an interaction exists between the depiction of the various selectable functions on the display screen and the color highlighting of the first operating element. If an operator has selected one of the functions, which are displayed on the display screen with different function color codes, by corresponding actuation of the first operating element, it can be provided according to the invention that the operator can recognize, merely by observing the first operating element and without observing the display screen, which function is selected, based on the correspondence of the color in which the first operating element is illuminated and the function color code assigned to the selected function. In particular, it may be provided that when cycling through different functions, the illumination color of the first operating element corresponds in each case to the function color code of the currently selected function. Alternatively, the first illumination unit may be configured to illuminate the first operating element in a color corresponding to a function color code assigned to a selected function only when the selection has been confirmed by corresponding actuation of the first operating element.

In one embodiment that is particularly simple and functionally reliable to operate due to a clear distinction between the different types of movement, the first operating element is to be rotated about an axis of rotation in the first type of movement and is to be displaced in the direction of the axis of rotation in the second type of movement. In this embodiment, the first operating element is designed as a rotary/push controller.

In particular, when several different function modes are selectable in assignment to a respective selectable function, for example to carry out the selected function in various intensity levels, it can be provided that the display screen is configured to display, After selecting one of the functions, a plurality of selectable function modes assigned to the selected function, and the first operating element can be moved in the first type of movement for selecting a function mode from the plurality of selectable function modes, and be moved in the second type of movement for confirming the selection of a function mode from the plurality of selectable function modes.

In order to display these various selectable function modes in a manner that makes them easier to identify for an operator by means of color highlighting, a function mode color code can be assigned to at least one, preferably each, function mode of the plurality of selectable function modes assigned to at least one, preferably each, function of the plurality of selectable functions, and the first illumination unit can be configured to illuminate the first operating element in a color corresponding to the function mode color code of the selected function mode, after selection and/or confirming the selection of one of the function modes by means of the first operating element.

In order to avoid irritation induced by an excessively large number of different illumination or display colors and operating errors resulting therefrom, it is proposed that the same function mode color code is assigned to at least two, preferably all, function modes assigned to at least one, preferably each, function of the plurality of selectable functions.

If, in the case of at least one, preferably each, function of the plurality of selectable functions, the function mode color code corresponds to the function color code of the assigned function for at least one, preferably each, function mode assigned thereto, the risk of incorrect operation induced by too many different colors is further reduced.

In one particularly preferred embodiment, the display screen can be a touchscreen, and at least one, preferably each, function of the plurality of selectable functions can be selectable by touching the display screen or/and the selection of at least one, preferably each, function of the plurality of selectable functions can be confirmable by touching the display screen, additionally to the selection by the first operating element.

In order to make it recognizable to an operator that the selection or the confirmation has been recognized, regardless of the manner in which a function has been selected, it is proposed that the first illumination unit is configured to illuminate the first operating element in a color corresponding to the function color code of the selected function, after selection and/or confirming the selection of a function of the plurality of selectable functions by touching the display screen.

If several function modes are selectable in assignment to one or more of the selectable functions, it can further be provided that at least one, preferably each, function mode of the plurality of selectable function modes is selectable by touching the display screen or/and the selection of at least one, preferably each, function mode of the plurality of selectable function modes is confirmable by touching the display screen.

In this context, it is also advantageous with regard to the clear highlighting of a selected function mode, if the first illumination unit is configured to illuminate the first operating element in a color corresponding to the function mode color code of the selected function mode, after selection and/or confirming the selection of a function mode of the plurality of selectable function modes by touching the display screen.

The operating system according to the invention can further comprise at least one second operating element, for example an operating button, wherein a function confirmed regarding its selection is activatable and/or deactivatable by means of the at least one second operating element.

In this case, it can be provided to increase operating safety that a function mode assigned thereto and confirmed regarding its selection is activatable and/or deactivatable by means of the at least one second operating element, in the case of a function confirmed regarding its selection.

In order to avoid incorrect operations, a respective second operating element can be provided in assignment to at least a part of the functions, preferably each function, of the plurality of selectable functions.

In order to also achieve a color interaction between the at least one second operating element and the display screen or the first operating element, it is proposed that a second illumination unit is provided in assignment to the at least one second operating element, and that the second illumination unit is configured to illuminate the at least one second operating element in a color corresponding to the function color code of the function confirmed regarding its selection and activatable and/or deactivatable by means of the at least one second operating element.

In order to make it recognizable to an operator that no function is selected, the second illumination unit can be configured to not illuminate the at least one second operating element or illuminate it in a neutral color when a function is not selected and/or not confirmed.

The first illumination unit can also be configured to not illuminate the first operating element or illuminate it in a neutral color when a function is not selected and/or not confirmed.

For a simple operation to be carried out, it can be provided that the at least one second operating element is configured as a push button.

The present invention further relates to a self-propelled construction machine, in particular an ground processing machine, such as a ground compactor, comprising an operating system constructed according to the invention.

The present invention is described in detail below with reference to the accompanying figures. In particular:

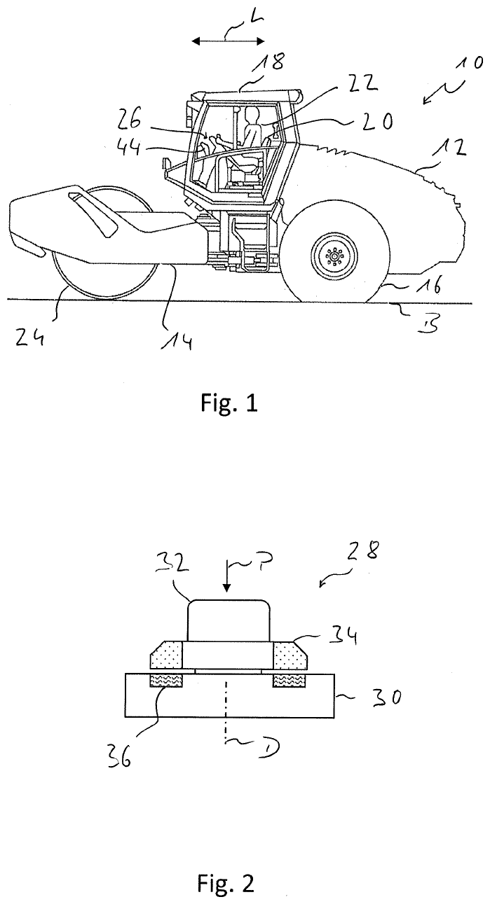

FIG. 1 shows a side view of a self-propelled construction machine designed as a ground compactor;

FIG. 2 shows a side view of an operating element designed as a rotary/push controller for an operating system, for example of the construction machine of FIG. 1;

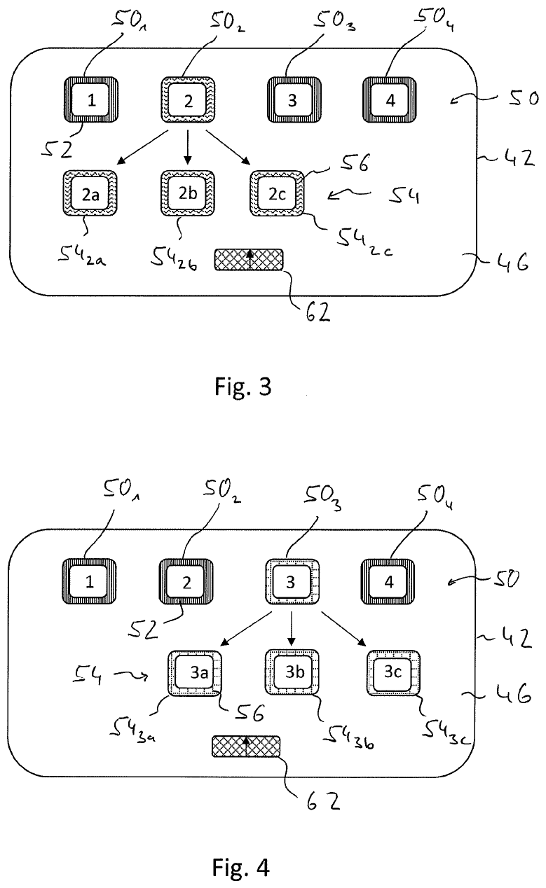

FIG. 3 shows a display screen of the operating system with a plurality of functions displayed thereon, wherein a plurality of function modes assigned to a selected function are displayed in assignment thereto;

FIG. 4 shows a depiction of a display screen corresponding to FIG. 3, wherein several selectable function modes assigned to another selected function are displayed;

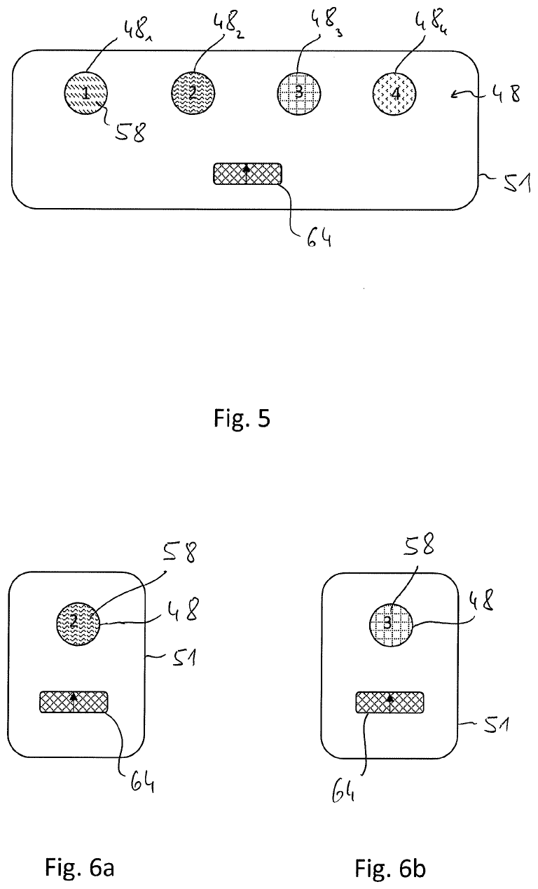

FIG. 5 shows an operating panel with a plurality of operating elements designed as push buttons;

FIGS. 6a and 6b show alternative embodiments of an operating panel with a push button providing an operating element;

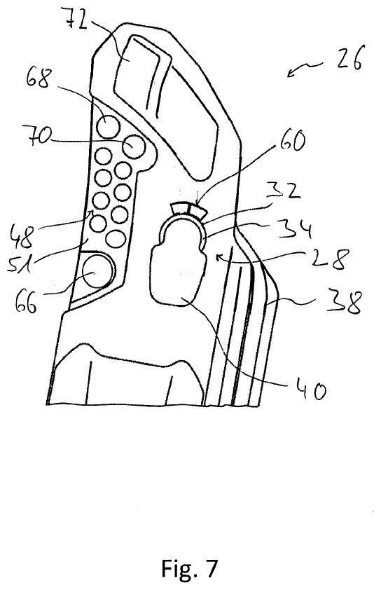

FIG. 7 shows a section of an armrest with system areas of the operating system integrated therein.

FIG. 1 shows, in a side view, a self-propelled construction machine 10 designed as a ground compactor, which successively comprises a rear carriage 12 and a front carriage 14 in a longitudinal direction L essentially corresponding to a direction of movement. On the rear carriage 12, wheels 16 driven by a drive unit also provided thereon for moving the construction machine 10 over a ground B, as well as an operator station 18, are provided. An operator 22 operating the construction machine 10 can take a seat 20 arranged in the operator station 18. A ground compaction roller 24 is rotatably supported on the front carriage 14 about a roller axis of rotation, so that when moving over the ground B, the latter is compacted by the load by means of the ground compaction roller 24.

An operating system 26 described in detail below is provided in the operator station 18, which can be utilized by the operator 22 to operate the construction machine 10.

It should first be noted that the construction machine 10 illustrated in FIG. 1 by means of a ground compactor comprising a front carriage 14 and a rear carriage 12 is only one example of a plurality of different construction machines operable by means of the operating system 26 described in detail below. For example, a ground compactor configured in a different manner could also form such a construction machine 10. Such a ground compactor could be, for example, an articulated ground compactor, which features two steering frames, each carrying a ground compaction roller, on a machine frame, which are pivotable with respect to the machine frame for steering the ground compactor. Other types of construction machines, such as wheel loaders, excavators, road milling machines, or the like, can also be operated by means of such an operating system 26 by an operator 22.

FIG. 2 shows a first operating element 28 designed as a rotary/push controller as an essential component of the operating system 26. The first operating element 28 comprises a controller 32 rotatably supported on a base 30 about an axis of rotation D and displaceable towards the base 30 in the direction of the axis of rotation D. As described in detail below, the controller 32 can be rotated about the axis of rotation D in a first type of movement and be moved towards the base 30 in the direction of an arrow P in a second type of movement.

The controller 32 can be designed to be transparent in an outer circumferential area 34 ring-like surrounding the axis of rotation D, so that light generated by means of a first illumination unit 36 provided on the base 30 is visible through this outer circumferential area 34, or the controller 32 is visible in the color of the light emitted by means of the first illumination unit 36. The first illumination unit 36 can also be designed to surround the axis of rotation D in a ring-like manner and can be configured as a so-called RGB-LED (Red-Green-Blue-LED) for generating light of various colors.

The first operating element 28 can be integrated into an armrest 38 provided laterally next to the seat 32 in the operator station 18, as illustrated in FIG. 7. A hand rest 40 can be provided in assignment to the first operating element 28 or the controller 32 thereof, so that the operator 22 can actuate the controller 32 with the hand resting on the hand rest 40 in an ergonomically advantageous manner.

The operating system 26 comprises a display screen 42 shown in principle in FIG. 3 as a further component. The display screen 42 can be arranged, for example, in a dashboard area 44 positioned in front of the seat 20 within the operator's 22 field of vision, but could fundamentally also be integrated into the armrest 38. The display screen 42 is advantageously executed as a touchscreen and features a touch-sensitive surface 46, so that operating commands can be entered into the operating system 26 by means of the display screen 42 by the operator 22 by touching the touch-sensitive surface 46. With the display screen 42 designed as a touchscreen and the first operating element 28 designed as a rotary/push controller, two system areas are thus integrated into the operating system 26, by means of which the operator 22 can enter operating commands.

A plurality of second operating elements 48 designed as push buttons are provided, for example, integrated into the armrest 38. For this purpose, for example, an operating panel 51 summarizing these second operating elements 48 can be provided on the armrest 38, which is positioned laterally next to the first operating element 28 and can thus also be operated by the operator with the hand resting on the hand rest 40. The operating panel 51 with the second operating elements 48 provided thereon provides a third system area of the operating system 26, by means of which the operator 22 can enter operating commands into the operating system 26 in the manner described below.

FIG. 3 illustrates that a plurality of functions 50 selectable by the operator 22 can be displayed on the display screen 42, for example in the form of tiles or other display symbols. In the illustrated example, these are four functions 50₁, 50₂, 50₃, 50₄, each represented by a tile. Examples of such functions are, for example, the compaction type, i.e., vibration and/or oscillation, the sprinkling of the compaction roller 24, for example with water and/or additive, a track offset of the compaction rollers provided on an articulated ground compactor, generally also referred to as crab steer, the illumination function, the operation of a grit spreader, the operation of an edge pressing device, the operation of a heating and air conditioning system, the operation of an audio system, and the like. By rotating the controller 32, the operator 22 can select one of the functions 50₁, 50₂, 50₃, 50₄ displayed on the display screen 42.

In order to make it easier for the operator to recognize the various functions, even when observing the ground 14 lying in front of the construction machine 10 with greater concentration, each function 50₁, 50₂, 50₃, 50₄ displayed on the display screen 42 is assigned a function color code, for example by a colored border area 52 surrounding the respective display tile. In this case, it can be provided, for example, that a respective function 50₁, 50₂, 50₃, 50₄ is displayed with the respective function color code when a function has been selected by rotating the controller 32. All functions not selected at this time, i.e., the functions 50₁, 50₃, 50₄ in the embodiment example of FIG. 3, are displayed in a neutral color, for example in white. Such a neutral color is thus, within the meaning of the present invention, a color which is not assigned to any function as a function color code.

If one of the functions 50₁, 50₂, 50₃, 50₄ is selected and accordingly displayed on the display screen 42 with the assigned function color code, the first illumination unit 36 is operated such that it generates light of the same color and thus illuminates and makes the controller 32 or the first operating element 28 appear in the color which corresponds to the function color code of the selected function, in this case the function 502. Thus, a consistent visual impression results for the operator 22 in the two system areas, display screen 42 on the one hand and first operating element 28 on the other hand, so that even a brief or fleeting glance either at the display screen 42 or the first operating element 28 indicates to the operator 22 which function has been selected. It must be taken into account that an operator 22, who is experienced in handling the construction machine 10, knows which function color code is assigned to which function. The ability to perceive the selected function both on the display screen 42 and on the first operating element 28 is particularly advantageous when the construction machine 10 is operated in the dark, for example.

After selecting one of the displayed and available functions 50₁, 50₂, 50₃, 50₄, i.e., the function 50₂ in the example shown in FIG. 3, the operator 22 confirms this selection by depressing and thereby displacing the controller 32 towards the base 30 in the direction of the arrow P.

After confirming the selected function, in the case of the example of FIG. 3, the function 50₂, available or selectable function modes 54 assigned to this selected function 50₂ can be displayed on the display screen 42 or, if they have already been displayed previously, they can be visually highlighted, for example. In the state shown in FIG. 3, three function modes 542a, 542b, 54_{2c} exist for the function 50₂. If, for example, the function 50₂ represents the sprinkling of the compaction roller 24, the function modes 54₂ₐ, 5426, 54_{2c} can reflect the intensity of the sprinkling, for example.

By moving the controller 32 of the first operating element 28 in the first type of movement, i.e., by rotating about the axis of rotation D, one of the function modes 54₂ₐ, 54_{2b}, 54_{2c} assigned to the function 50₂ can be selected. After selection has been made, the selected function mode can then be confirmed by moving in the second type of movement, i.e., by depressing the controller 32.

Each function mode 54₂ₐ, 54_{2b}, 54_{2c} assigned to a respective function 50₁, 50₂, 50₃, 50₄ is assigned a function mode color code. This can also be reproduced, for example, by a colored border 56 of a display tile representing a respective function mode 54₂ₐ, 54_{2b}, 54_{2c}. In order to avoid irritation caused by too many different displayed color codes, it is preferably provided that, in the case of the function modes 54 assigned to a respective function 50, the respective function mode color code corresponds to the function color code of the assigned function. In the state of FIG. 3, this means that the three function modes 54₂ₐ, 54_{2b}, 54_{2c} are displayed with a function mode color code which corresponds to the function color code of the function 50₂. At the same time, the first operating element 28 is also illuminated by means of corresponding actuation of the first illumination unit 36, after selecting and confirming, for example, the function 50₂, with the color code or color assigned to this function and also to the function modes 54₂ₐ, 54_{2b}, 54_{2c} assigned thereto.

After selecting and confirming one of the functions 50 and selecting and confirming one of the function modes 54 assigned to the selected and confirmed function, it is necessary to activate the selected and confirmed function with the selected and confirmed function mode. In the case of sprinkling, this means, for example, that after selecting the sprinkling and the intensity of the sprinkling and also confirming the selection, the sprinkling does not yet start. The sprinkling is activated by actuating one of the second operating elements 48 of the operating panel 51 only when, for example, the construction machine 10 has reached the location at which the sprinkling should begin, or deactivated again after prior activation. For this purpose, FIG. 5 shows, by way of example, the operating panel 51 with the four second operating elements 48₁, 48₂, 48₃, 48₄ designed as push buttons and assigned to the functions 50₁, 50₂, 50₃, 50₄. In order to also generate a consistent appearance here, each of these second operating elements 48₁, 48₂, 48₃, 48₄ assigned to a specific function is advantageously illuminated by means of a respectively assigned second illumination unit 58 such that it is illuminated in a color corresponding to the function color code of the assigned function, or is visible to the operator 22. Here it can be provided, for example, that as long as a function 50 is not selected and/or confirmed, the assigned second operating element 48 is not illuminated or is illuminated in a neutral color, for example white color. After selecting a function 50, the second operating element 48 assigned to the selected function can then be illuminated in the color which corresponds to the function color code of the assigned and selected function.

After selecting and confirming a function 50 and selecting and confirming of a function mode 54 assigned to this function by means of the first operating element 28, and activating the selected and confirmed function with the selected and confirmed function mode, the function is activated by means of actuation of the assigned second operating element 48, or the assigned system area is put into operation, or deactivated and put out of operation again by renewed actuation.

FIG. 4 illustrates a state in which the function 50₃ has been selected and confirmed by means of Substitute Specification-Clean corresponding actuation of the first operating element 28, and accordingly the function modes 54₃ₐ, 54_{3b}, 54_{3c} assigned to this function 50₃ are displayed or highlighted. After selecting and confirming one of these three function modes 54₃ₐ, 54_{3b}, 54_{3c}, the assigned function with the selected and confirmed function mode can then be activated by acting on the second operating element 48₃.

In the case of functions to which no differentiating function modes are assigned, it can be provided, for example, that After selecting a corresponding function, no function modes are displayed on the display screen 42, whereby the operator 22 is signaled that the selected and confirmed function can then be immediately activated or deactivated again by acting on the assigned second operating element 48.

In order to be able to activate one or more other functions or function modes after selecting and confirming and also activating a function or function mode, a Back function can be provided, which can be activated, for example, by buttons 60 provided on the armrest 38 in the area of the first operating element 28. The Back function leads back to a previous display level, so that, for example, after the function modes 54₂ₐ, 54_{2b}, 54_{2c} existing in assignment to the function 50₂ were displayed corresponding to the state of FIG. 3, and one of these function modes 54₂ₐ, 54_{2b}, 54_{2c} was selected and then also confirmed, and this function was possibly also activated, a transition back to a state takes place by means of activation of the Back function, in which one of the selectable functions 50₁, 50₂, 50₃, 50₄ is displayed by means of actuation of the first operating element 28, and, for example, no assigned function modes are displayed, whereupon, for example, while the function 50₂ is still activated, the function 50₃ can be selected and confirmed, and after display of the function modes 54₃ₐ, 54_{3b}, 54_{3c} assigned thereto, one of these function modes 54₃ₐ, 54_{3b}, 54_{3c} can be selected and confirmed, and this function can be activated with the selected and confirmed function mode by means of actuation of the second operating element 48₃.

In particular when the display screen 42 is designed as a touchscreen with a touch-sensitive surface 46, it can also be provided in the operating system 26 that the selection and confirmation procedures described above can be carried out not only by means of the first operating element 28, but also by acting on the touch-sensitive surface 46. For example, after display of the four functions 50₁, 50₂, 50₃, 50₄, this function can be selected, for example, by touching the touch-sensitive surface 46 in the area of the tile representing the function 50₂. After selection has been made, this selection can be confirmed by renewed touching of the tile representing the function 50₂, or the selection made by single touching of the touch-sensitive surface 46 can already be considered as confirmation. In order to then select one of the assigned function modes 54₂ₐ, 54_{2b}, 54_{2c}, the touch-sensitive surface 46 is touched in the area of one of the tiles representing the function modes 54₂ₐ, 54_{2b}, 54_{2c}, wherein a confirmation takes place either already by the single touch or by renewed touching. The activation of the function selected and confirmed in this manner by means of the display screen 52 with the selected and confirmed function mode then takes place again by actuating the second operating element 482 assigned to this function.

The Back function can also be selected by touching the display screen 42 or the touch-sensitive surface 46 in the area of a tile 62 representing the Back function. Alternatively or additionally, a button 64 representing the Back function or activating it upon corresponding actuation can be provided on the operating panel 51.

Since a plurality of different functions can be selectable with the operating system, depending on the type of construction machine 10, it can be advantageous not to provide a separate second operating element 48 in assignment to each selectable function on the operating panel 51. For example, as illustrated in FIGS. 6a and 6b, a single second operating element 48 with a second illumination unit 58 assigned thereto can be provided. After selecting one of the selectable functions 50, for example the function 50₂ in the state of FIG. 3, the second illumination unit 58 assigned to the single second operating element 48 can be actuated or operated such that the second operating element 48 is illuminated with a color which corresponds to the function color code of the function 50₂ selected in this state. In this case, it is again irrelevant whether this selection and possibly confirmation took place by means of the first operating element 28 or the display screen 42 designed as a touchscreen. By acting on the second operating element 48, the function 50₂ can then be activated or deactivated with the selected and confirmed function mode in the case of the state of FIG. 6a. In the state shown in FIG. 6b with selecting and confirming function 50₃ and selecting and confirming one of the three function modes 54₃ₐ, 54_{3b}, 54_{3c}, this function can be activated and also deactivated again by means of influence on the second operating element 48 of the operating panel 51, which is then illuminated in this state in a color that corresponds to the function color code of the function 50₃.

In connection with the second operating elements 48, independently of whether a separate second operating element 48 is assigned to each selectable function 50 or whether one or possibly also several second operating elements 48 are assigned to several selectable functions 50 in each case, it can also be provided that an illumination of the second operating elements 48 with the color assigned to a respective function takes place only when a complete selecting and confirming the selection has been carried out. If several selectable function modes 54 exist for a selectable function 50, the assigned or to be utilized second operating element 48 remains unilluminated or illuminated in a neutral color as long as no function mode to be selected has been selected and confirmed. Only when it is clearly defined which function is to be activated with which function mode, the assigned second operating element 48 is illuminated in the corresponding color, so that it is recognizable to the operator 22 that an activation of a system area of the construction machine 10 assigned to the selected function is possible only in this state. If no function modes exist for a selectable function 50, the assigned second operating element 48 can be illuminated in the corresponding color already after selecting and confirming this function, so that the operator 22 is signaled that an activation of the selected and also confirmed function is possible.

In the operating system 26, it can in particular also be provided that the first operating element 28 is illuminated in a neutral color in a state in which no function is selected and/or confirmed. The transition to an illumination with a color which corresponds to the color of the function color code of a selected function can then take place when the function has been selected by moving the controller 32 in the first type of movement, or can also take place only when the selection of the function has been confirmed by moving the controller 32 in the second type of movement. Also upon selection of a function by means of the display screen 42 designed as a touchscreen, the transition from the illumination in a neutral color, i.e., white for example, to the illumination with a color which corresponds to the function color code of the selected function, can take place when a function has been selected by single touching of the display screen 42, for example, and has possibly also already been confirmed by single touching, or can also take place only when the selection of the selected function has been confirmed by renewed touching after selection has been made.

Finally, it should also be noted that the operating system 26, for example integrated into the armrest 38 shown in FIG. 7, can also feature further operating elements. For example, an emergency stop switch 66 can be integrated into the operating panel 51, the actuation of which results in the immediate deactivation of all system areas or the entire construction machine 10. A start/stop switch 68, or a switch 70 activating and deactivating a parking brake, as well as a drive lever 72 to be actuated by the operator 22 in the manner of a joystick for moving the construction machine 10, can also be integrated into the armrest 38.

1. An operating system for a self-propelled construction machine, comprising:
a first operating element, wherein the first operating element is to be moved in a first type of movement for selection of a function from a plurality of selectable functions and is to be moved in a second type of movement for confirming the selection of a function from the plurality of selectable functions, wherein a first illumination unit is assigned to the first operating element for illuminating the first operating element,
a display screen for displaying the functions selectable and/or selected by means of the first operating element,
wherein at least one function of the plurality of selectable functions is assigned a function color code, and wherein the first illumination unit is configured to illuminate the first operating element in a color corresponding to the function color code of the selected function, after selection and/or confirming the selection of one of the functions by means of the first operating element.

2. The operating system according to claim 1,
wherein the first operating element is to be rotated about an axis of rotation for movement in the first type of movement and is to be displaced in the direction of the axis of rotation for movement in the second type of movement.

3. The operating system according to claim 1,
wherein the display screen is configured to display, after selection of one of the functions, a plurality of selectable function modes assigned to the selected function, and that the first operating element is to be moved in the first type of movement for selecting a function mode from the plurality of selectable function modes and is to be moved in the second type of movement for confirming the selection of a function mode from the plurality of selectable function modes.

4. The operating system according to claim 3,
wherein a function mode color code is assigned to at least one function mode of the plurality of selectable function modes assigned to at least one function of the plurality of selectable functions, and that the first illumination unit is configured to illuminate the first operating element in a color corresponding to the function mode color code of the selected function mode, after selection and/or confirming the selection of one of the function modes by means of the first operating element.

5. The operating system according to claim 4,
wherein the same function mode color code is assigned to at least two function modes assigned to at least one function of the plurality of selectable functions.

6. The operating system according to claim 4,
wherein for at least one function mode assigned to at least one function of the plurality of selectable functions, the function mode color code corresponds to the function color code of the assigned function.

7. The operating system according to claim 1,
wherein the display screen is a touchscreen, and that at least one function of the plurality of selectable functions is selectable by touching the display screen and/or the selection of at least one function of the plurality of selectable functions is confirmable by touching the display screen.

8. The operating system according to claim 7,
wherein the first illumination unit is configured to illuminate the first operating element in a color corresponding to the function color code of the selected function, after selection and/or confirming the selection of a function from the plurality of selectable functions by touching the display screen.

9. The operating system according to claim 6,
wherein the display screen is configured to display, after selection of one of the functions, a plurality of selectable function modes assigned to the selected function, and that the first operating element is to be moved in the first type of movement for selecting a function mode from the plurality of selectable function modes and is to be moved in the second type of movement for confirming the selection of a function mode from the plurality of selectable function modes, and
wherein at least one function mode of the plurality of selectable function modes is selectable by touching the display screen and/or the selection of at least one function mode of the plurality of selectable function modes is confirmable by touching the display screen.

10. The operating system according to claim 9,
wherein a function mode color code is assigned to at least one function mode of the plurality of selectable function modes assigned to at least one function of the plurality of selectable functions, and that the first illumination unit is configured to illuminate the first operating element in a color corresponding to the function mode color code of the selected function mode, after selection and/or confirming the selection of one of the function modes by means of the first operating element, and
wherein the first illumination unit is configured to illuminate the first operating element in a color corresponding to the function mode color code of the selected function mode, after selection and/or confirming the selection of a function mode from the plurality of selectable function modes by touching the display screen.

11. The operating system according to claim 1,
wherein at least one second operating element is provided, and that a function confirmed regarding its selection is activatable and/or deactivatable by means of the at least one second operating element.

12. The operating system according to claim 11,
wherein the display screen is configured to display, after selection of one of the functions, a plurality of selectable function modes assigned to the selected function, and that the first operating element is to be moved in the first type of movement for selecting a function mode from the plurality of selectable function modes and is to be moved in the second type of movement for confirming the selection of a function mode from the plurality of selectable function modes, and
wherein a function mode assigned thereto and confirmed regarding its selection is activatable and/or deactivatable by means of the at least one second operating element, in the case of a function confirmed regarding its selection.

13. The operating system according to claim 11,
wherein a respective second operating element is provided in assignment to at least a part of the functions of the plurality of selectable functions.

14. The operating system according to claim 11,
wherein a second illumination unit is provided in assignment to the at least one second operating element, and that the second illumination unit is configured to illuminate the at least one second operating element in a color corresponding to the function color code of the function confirmed regarding its selection and activatable and/or deactivatable by means of the at least one second operating element.

15. The operating system according to claim 14,
wherein the second illumination unit is configured to not illuminate the at least one second operating element or illuminate it in a neutral color when a function is not selected and/or not confirmed.

16. The operating system according to claim 11,
wherein the at least one second operating element is configured as a push button.

17. The operating system according to claim 1,
wherein the first illumination unit is configured to not illuminate the first operating element or illuminate it in a neutral color when a function is not selected and/or not confirmed.

18. Self-propelled construction machine comprising an operating system according to claim 1.
